(19) United States
(12) Patent Application Publication
(10) Pub. No.: US 2012/0072366 A1
(43) Pub. Date: Mar. 22, 2012

(54) METHOD, SYSTEM AND PROGRAM PRODUCT FOR INDEPENDENT SOFTWARE VENDOR (ISV) SOLUTION EVALUATION

(75) Inventors: AMRISH VASANT CHAUBAL, Bangalore (IN); DIPTIMAN DASGUPTA, Kolkata (IN); GIRIDHAR KRISHNAMURTHI, Bangalore (IN); MYNAMPATI PRABHAKAR, Nellore Dist. (IN); SIDDHARTH N. PUROHIT, Allen, TX (US); AMARDEEP RAIKER, Bangalore (IN)

(73) Assignee: INTERNATIONAL BUSINESS MACHINES CORPORATION, Armonk, NY (US)

(21) Appl. No.: 12/886,242

(22) Filed: Sep. 20, 2010

(51) Int. Cl. G06Q 99/00

(52) U.S. Cl. 705/347

(57) ABSTRACT

A computer assisted method, system and related program product for evaluating and selecting an independent software vendor solution from a plurality of independent software vendor solutions is predicated upon a structured information capture framework and a scoring model based upon the structured information capture framework. The scoring model uses a multilevel weighted scoring algorithm that uses inputted parameter level data to calculate a plurality of subject level scores. The plurality of subject level scores is secondarily weighted to provide a plurality of dimension level scores. The plurality of dimension level scores is further primarily weighted to provide a final score for each of the plurality of independent software vendor solutions.

### FIELD OF THE INVENTION

The invention relates generally to independent software vendors and related solutions. More particularly, the invention relates to methods for evaluating independent software vendors and related solutions that may be used within services oriented architectures.

### BACKGROUND

As computer technology has advanced and computing capabilities have evolved, it has become more common for computer hardware products and computer software products to be offered to industry customer entities within the context of integrated information technology solutions rather than independent hardware products and independent software products. Such offers of integrated information technology solutions are desirable within the context of industry customer entities insofar as integrated information technology solutions often provide an opportunity for an integrated information technology solutions provider to distribute integrated information technology solution development costs over a plurality of potential industry customer entities within a particular industry. Thus, the particular industry customer entities may readily avoid the development costs associated with independent development of their own integrated information technology solutions, which may include independent computer hardware products and independent computer software products.

Also common within advanced computing technology is a services oriented architecture. A services oriented architecture generally provides that services, such as integrated information technology solution services, are typically offered or implemented across multiple domains within a particular industry customer entity within a particular industry.

Within the context of both integrated information technology solutions and services oriented architectures, it is common for an integrated information technology solutions provider to evaluate independent software vendors for purposes of integrating independent software vendor solutions into integrated information technology solutions. Given the quantity of possible independent software vendor solutions, such evaluations may become cumbersome.

Thus, desirable are methods, apparatus and program products for efficiently evaluating independent software vendor solutions that may be used within integrated information technology solutions, which in turn may be used within services oriented architectures.

Various methods, systems and program products are known in the information technology art for evaluating software products that are used within the information technology art.

For example, Lee et al., in U.S. Patent Application Publication Number 2008/0312979, teaches a method and a system for estimating financial benefits of packaged application service products. This particular method and system include a view layer, a modeling layer and an estimation layer, each of which may be utilized over a distributed communications network.

Desirable are additional methods, systems and program products that may assist in evaluating and selecting independent software vendor solutions that may be used within services oriented architectures for providing desirable integrated information technology solutions for particular industry related information technology needs.

### BRIEF SUMMARY

Embodiments of the invention provide a computer assisted method, a system and a program product for evaluating and selecting a particular independent software vendor solution that may be used within a services oriented architecture for providing an integrated information technology solution for a particular industry related information technology need.

The particular computer assisted method, system and program product in accordance with the invention provide in a first instance for defining a particular information capture framework to capture particular designated information regarding a plurality of independent software vendor solutions. The information capture framework includes high level dimensions, intermediate level subjects and low level parameters.

The particular computer assisted method, system and program product in accordance with the invention also provide, in a second instance, for defining a scoring model based upon the information capture framework. The scoring model includes a scoring algorithm that includes a primary weighting of high level dimensions and a secondary weighting of intermediate level subjects. The scoring model also provides a designated response range for low level parameters.

By defining such an information capture framework and defining such a related scoring model that includes such a multilevel weighted scoring algorithm, the particular embodiments of the invention provide for an efficient and reproducible computer assisted method, system and program product for evaluating and selecting, absent bias, a particular independent software vendor solution that may be used within a services oriented architecture.

A particular method in accordance with the invention includes defining within a computer system a structured information capture framework for evaluation of a plurality of independent software vendor solutions. The particular method also includes defining within the computer system a scoring model that correlates with the structured information capture framework and includes a multilevel weighted scoring algorithm. The particular method also includes inputting into the computer system parameter level data for the plurality of independent software vendor solutions while using the structured information capture framework. The particular method also includes calculating for each of the plurality of independent software vendor solutions while using the multilevel weighted scoring algorithm a final score to provide an independent software vendor solution ranking.

A particular system in accordance with the invention includes a computer programmed to: (1) define a structured information capture framework for evaluation of a plurality of independent software vendor solutions; (2) define a scoring model that correlates with the structured information capture framework and includes a multilevel weighted scoring algorithm; (3) receive parameter level data for the plurality of independent software vendor solutions while using the structured information capture framework; and (4) calculate for each of the plurality of independent software vendor solutions while using the multilevel weighted scoring algorithm a final score to provide an independent software vendor solution ranking.

A particular software program product in accordance with the invention includes a tangible medium encoded to: (1) define within a computer system a structured information capture framework for evaluation of a plurality of independent software vendor solutions; (2) define within the computer system a scoring model that correlates with the structured information capture framework and includes a multilevel weighted scoring algorithm; (3) receive within the computer system parameter level data for the plurality of independent software vendor solutions while using the structured information capture framework; and (4) calculate for each of the plurality of independent software vendor solutions while using the multilevel weighted scoring model a final score to provide an independent software vendor solution ranking.

### BRIEF DESCRIPTION OF THE DRAWINGS

The objects, features and advantages of the invention are understood within the context of the Detailed Description of the Embodiments, as set for the below. The Detailed Description of the Embodiments is understood within the context of the accompanying drawings, that form a material part of this disclosure, wherein:

FIG. 1 shows a schematic text diagram illustrating the two basic information capture framework and scoring model component parts in accordance with the embodiments for evaluating and selecting an independent software vendor solution in accordance with the embodiments.

FIG. 2 shows a schematic process flow diagram illustrating in greater detail integration of the two basic information capture framework and scoring model component parts for evaluating and selecting an independent software vendor solution in accordance with the embodiments.

FIG. 3 shows a plurality of critical dimensions and related details that may be considered for evaluating and selecting an independent software vendor solution in accordance with the embodiments.

FIG. 4A and FIG. 4B shows a plurality of dimensions, subjects and parameters that may be considered for evaluating and selecting an independent software vendor solution in accordance with the embodiments.

FIG. 5 shows a typical request for information questionnaire comprising parameter level inquiries that are aligned with particular dimensions for evaluation and selection of an independent software vendor solution in accordance with the embodiments.

FIG. 6A and FIG. 6B show the plurality of dimensions, subjects and parameters that may be considered for evaluating and selecting an independent software vendor solution in accordance with FIG. 4A and FIG. 4B, but to which are now assigned weighting factors in accordance with the embodiments.

FIG. 7 shows a schematic text diagram illustrating in greater detail the specifics of a multilevel weighted scoring algorithm that may be used within the scoring model for evaluation and selection of an independent software vendor solution in accordance with the embodiments.

FIG. 8 shows a computer system in accordance with the embodiments for evaluation and selection of an independent software vendor solution in accordance with the embodiments.

FIG. 9, FIG. 10 and FIG. 11 show exemplary request for information questions and related considerations for each of the Business Alignment, Architectural Alignment and Technical Alignment dimensions in accordance with the embodiments.

FIG. 12, FIG. 13 and FIG. 14 show exemplary request for information response and scoring considerations for each of the Business Alignment, Architectural Alignment and Technical Alignment dimensions in accordance with the embodiments.

### DETAILED DESCRIPTION OF THE EMBODIMENTS

The embodiments, which include a computer assisted method, a system and a program product for evaluating and selecting an independent software vendor solution that may be used within the context of a services oriented architecture, is understood within the context of the description set forth below. The description set forth below is understood within the context of the drawings described above.

The computer assisted method, the system and the program product in accordance with the embodiments are used within the context of evaluating and selecting an independent software vendor solution that may be used within the context of a services oriented architecture. The particular computer assisted method, system and program product in accordance with the embodiments provide for an efficient and unbiased ranking of a plurality of independent software vendor solutions so that an independent software vendor solution may be efficiently selected, absent bias.

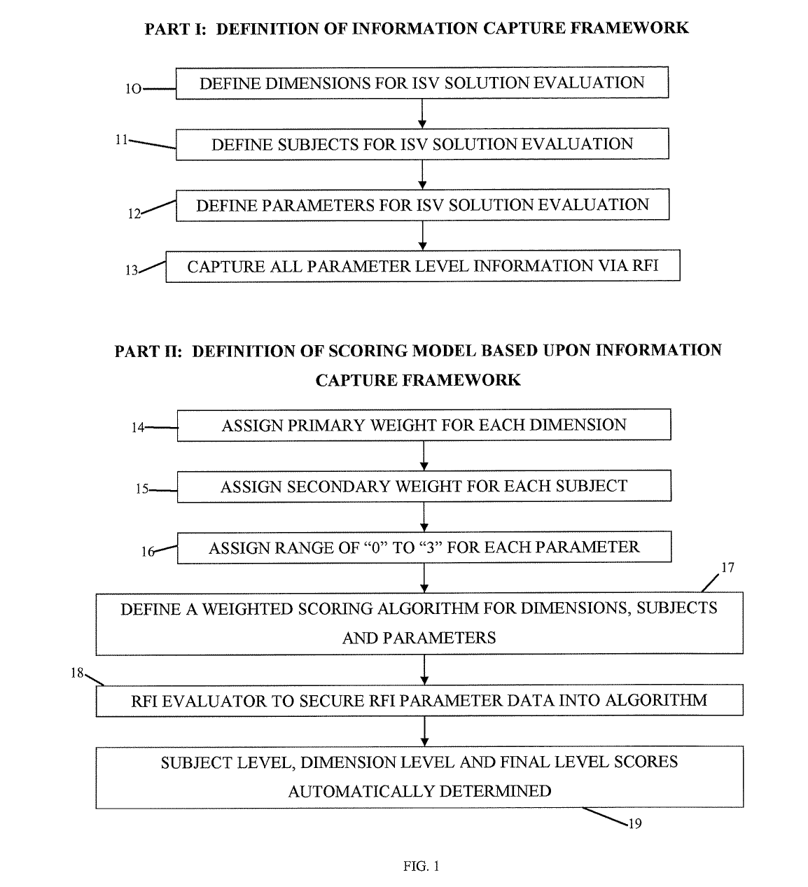

FIG. 1 shows a block text diagram illustrating two basic component parts in accordance with the embodiments for evaluating and selecting an independent software vendor solution, that may be used within the context of a services oriented architecture. As is illustrated within the block text diagram of FIG. 1, the two basic component parts of the embodiments include: (1) a part I definition of an information capture framework for capturing selected information with respect to a plurality of independent software vendor solutions; and (2) a part II definition of a scoring model that is based upon the foregoing part I information capture framework.

As is illustrated in FIG. 1, the part I definition of the information capture framework includes four subcomponent elements.

A first of the four subcomponent elements, which is illustrated in connection with reference numeral 10, provides for a definition of dimensions for a relevant independent software vendor solution evaluation. Within the context of the instant embodiments and the invention, such dimensions are intended to include broad categories of inquiry for which specific information about a plurality of independent software vendor solutions is desired. Specific examples of such dimensions for evaluation of a plurality of independent software vendor solutions are illustrated in greater detail below.

A second of the four subcomponent parts, which is illustrated in connection with reference numeral 11, provides for an optional definition of a plurality of subjects that correlate with the dimensions. The subjects, if defined and present, are intended to provide a logical division of subject matter for each dimension, under circumstances where the subject matter of each dimension is amenable to division into particular subjects. Specific examples of subjects for evaluation of a plurality of independent software vendor solutions are also illustrated more specifically below.

A third of the four subcomponent parts, which is illustrated in connection with reference numeral 12, provides for a definition of parameters that correlate with the optional subjects and the dimensions. The parameters, which are necessarily present within the context of each of the dimensions, whether or not a division of subject matter into subjects is present within the context of a particular dimension, are intended to provide specific inquiry level information definition regarding specific characteristics of a particular independent software vendor solution. Specific examples of parameters for evaluation of a plurality of independent software vendor solutions are also illustrated more specifically below.

Finally, the part I definition of the information capture framework component of the embodiments provides within the context of reference numeral 13 that all parameter information within the information capture framework is intended to be captured within the context of a request for information (RFI) inquiry that is intended to be solicited from the plurality of independent software vendors from whom a particular independent software vendor solution is desired to be evaluated and selected in accordance with the embodiments.

Thus, in concert with the above, the first part I component information capture framework of the instant embodiments provides for parameter level information capture that is further organized in a multilevel fashion arranged beneath particular subject areas that are in turn arranged beneath particular dimension areas. The particular parameter level inquiries are presented to a target plurality of independent software vendors for evaluation and selection within the context of a request for information (RFI) inquiry.

The second component part II of the embodiments that is also illustrated in FIG. 1 is a definition of a scoring model based upon the part I information capture framework.

In order to define such a part II scoring model based upon the part I information capture framework, the second component part II of the instant embodiments first provides for assigning a primary weighting factor to each dimension within the part I information capture framework, in accordance with reference numeral 14.

In general, and preferably, primary weighting factors for particular dimensions will typically be arbitrarily assigned predicated upon a perceived significance of a particular dimension in comparison with the remaining dimensions that are defined within the information capture framework for evaluation and selection of independent software vendor solutions. Typically, but not exclusively, the primary weighting factors for a plurality of dimensions will sum to unity.

In accordance with reference numeral 15, the part II scoring algorithm based upon the part I information capture framework next provides for assigning a secondary weighting factor for each optional subject that is aligned beneath a particular dimension. Similarly with the primary weighting factors assigned to the individual dimensions, the secondary weighting factors that are assigned to the individual subjects aligned beneath a particular dimension are also arbitrarily assigned predicated upon a perceived significance of a particular subject in comparison with the remaining subjects that are defined within the information capture framework for evaluation and selection of independent software vendor solutions. Typically, but not exclusively, the secondary weighting factors for a plurality of subjects that is aligned beneath a particular specific dimension will also sum to unity.

Next, in accordance with reference numeral 16, the particular part II scoring model predicated upon the particular part I information capture framework provides, for example and without limitation, that each parameter within the plurality of parameters is assigned a range that ranges from “0” to “3.” For further exemplary consideration, “0” is a minimum and least favorable response to a particular parameter inquiry and “3” is a maximum and most favorable response to the particular parameter inquiry.

In accordance with reference numeral 17, the particular part II scoring model based upon the particular part I information capture framework provides for definition of a weighted scoring algorithm based upon dimensions, subjects and parameters (i.e., a multilevel weighted scoring algorithm). Although the embodiments are by no means limited, preferably such a weighted scoring algorithm may preferentially utilize a “bottom-up” evaluation and calculation that: (1) first considers individual parameters that contribute to a particular subject or dimension; (2) next considers individual subjects that contribute to a particular dimension; and (3) finally considers all dimensions in deriving and arriving at a final scoring for an evaluation and selection of a particular independent software vendor solution from a plurality of independent software vendor solutions.

As is understood by a person skilled in the art, as a result of assigning particular values from “0” to “3” for responses to individual parameter level inquiries, a particular scoring algorithm in accordance with the part II scoring model may be structured to automatically calculate: (1) a particular subject score from a plurality of parameters aligned with a particular subject; (2) a particular dimension score from a plurality of parameters and/or subjects aligned beneath a particular dimension; and (3) a particular final score from a plurality of dimension scores.

In accordance with reference numeral 18, the part II scoring algorithm predicated upon the part I information capture framework next provides that a request for information evaluator will secure into the weighted scoring algorithm responses to individual request for information parameter data. Thus, within the context of the embodiments as presently presented, but not necessarily limited, a request for information evaluator is intended to assure that a value from “0” to “3” is entered for each parameter inquiry beneath a subject or dimension within the information capture framework.

Once all of the intended parameter level data has been secured by such a request for information evaluator, the foregoing scoring algorithm in accordance with reference numeral 19 preferably automatically calculates the individual subject level data and scores, the individual dimension level data and scores, and the aggregate final level data and scores that are desirable to evaluate and select an independent software vendor solution in accordance with the embodiments.

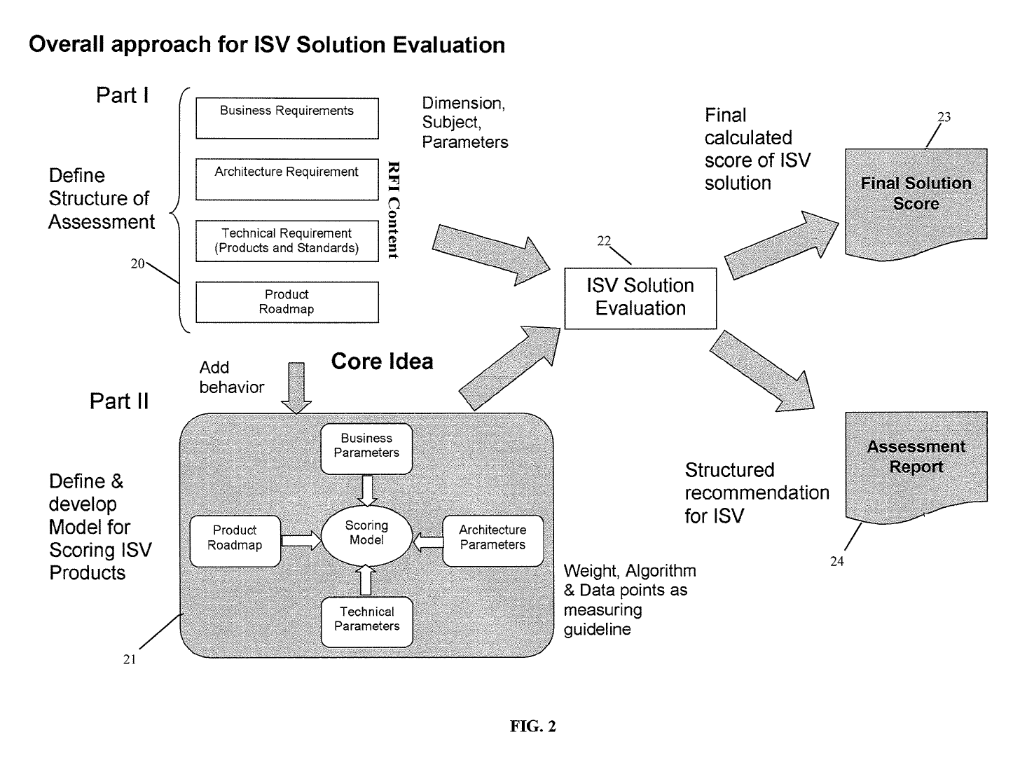

FIG. 2 shows a schematic process flow diagram that further clarifies and amplifies upon the two core component parts of the independent software vendor solution evaluation and selection that is illustrated in FIG. 1.

FIG. 2 first shows the part I information capture framework aspects of FIG. 1, along with a related request for information document 20 that is directed to dimensions that include, but are not necessarily limited to Business Requirements (or Business Alignment), Architecture Requirements (or Architecture Alignment), Technical Requirements (or Technical Alignment) and Product Roadmap (or Product Roadmap Alignment). Particulars of the foregoing four dimensions are discussed in further detail below.

FIG. 2 also shows the part II scoring model 21 aspects of FIG. 1, that derive from and correlate with the request for information document 20 for which individualized parameter level input and responses are requested. In concert with the part I information capture framework considerations and part II scoring model considerations of FIG. 1, FIG. 2 also intends that a request for information evaluator will secure and interpret, if not necessarily transcribe, parameter data from a request for information response, and that an appropriately weighted multilevel scoring algorithm will automatically calculate within the context of an independent software vendor solution evaluation and selection 22 a final solution score 23 that may be used within the context of a structured recommendation and assessment report 24 of a particular independent software vendor solution.

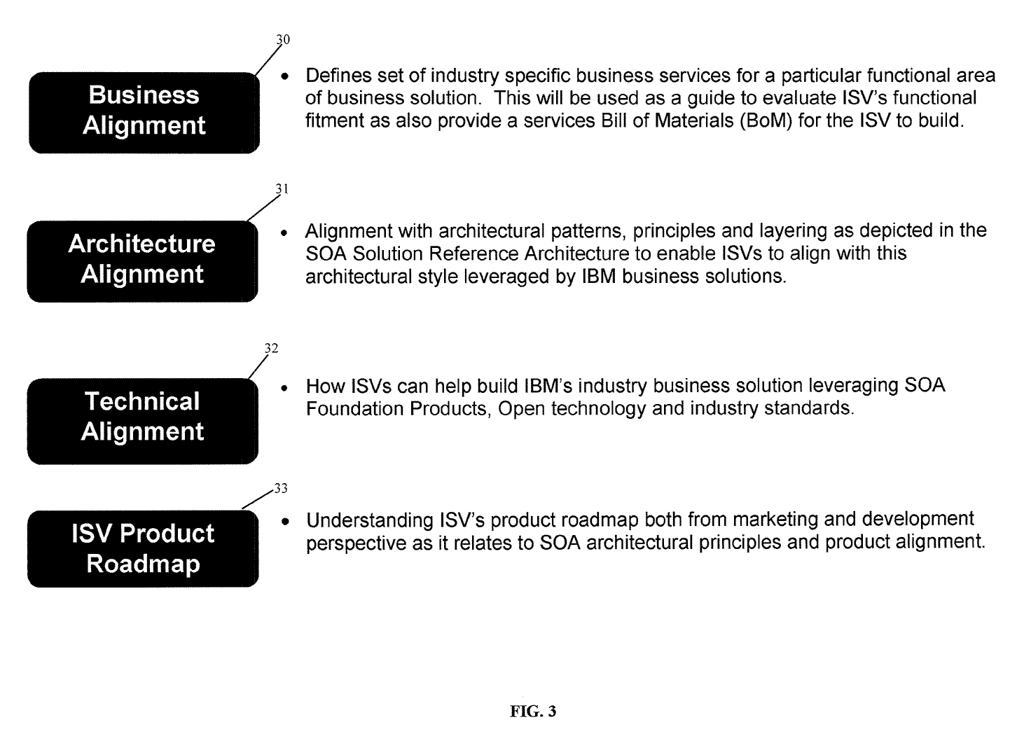

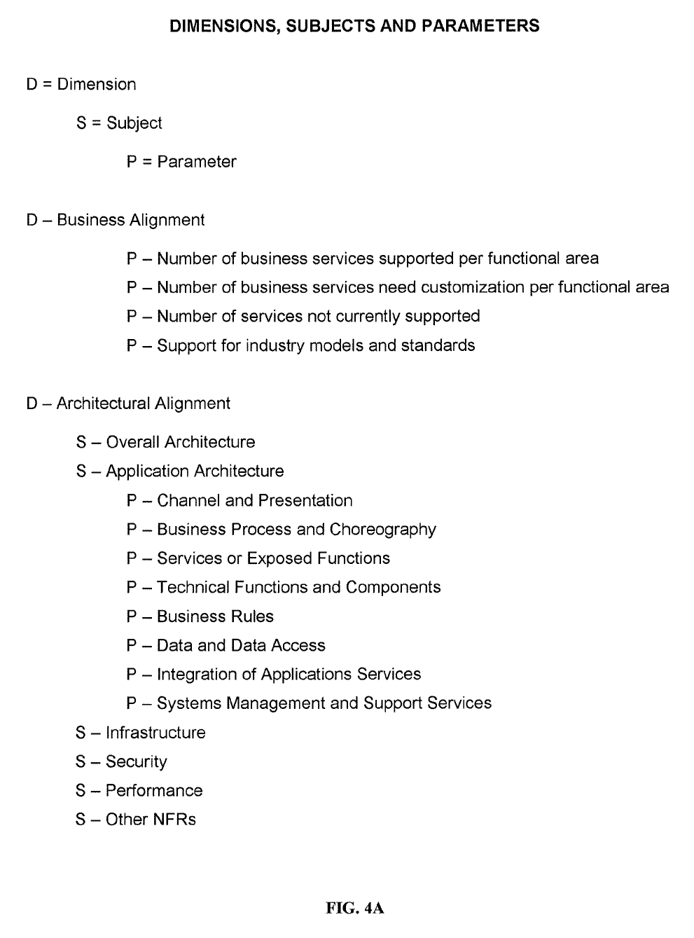

The particular dimensions that are discussed above within the context of the structured information framework of FIG. 1 and illustrated more specifically within FIG. 2 at reference numeral 20, are listed and defined with additional specificity in FIG. 3.

In that regard, the Business Alignment 30 dimension is intended to define a set of industry specific business services for a particular functional area of a business solution. Thus, as further defined within FIG. 3, the Business Alignment 30 dimension is intended to ascertain whether a particular independent software vendor is situated to functionally fit with respect to a specific industry for which specific business services are intended to be provided within the context of a specific business solution.

Further, the Architecture Alignment 31 dimension is intended to discern for an independent software vendor alignment with architectural patterns, principles and layering that are presently used by the request for information requester. Thus, such architectural alignment is intended to assure that an independent software vendor is optimally architecturally able to produce a solution that is readily integrated by the request for information requester.

Still further, the Technical Alignment 32 dimension is intended to discern and ascertain the extent to which an independent software vendor can help assist in building a requester's industry specific business solution while leveraging services oriented architecture foundation products, open technology and industry standards. Thus, such technical alignment is intended to discern and ascertain how well adapted and positioned a specific independent software vendor is to utilize the same software tools and protocols that are presently used by the request for information requester.

Finally, the ISV Product Roadmap 33 dimension is intended to understand an independent software vendor's product roadmap from both a marketing perspective and a development perspective, in particular as it relates to services oriented architecture principles and product alignment. Thus, such an independent software vendor product roadmap alignment is intended to assure that a particular independent software vendor is positioned, for at least the near term of perhaps three years, to provide independent software vendor solutions that are readily integrated and improved in conjunction with a request for information requester's current architectural principles.

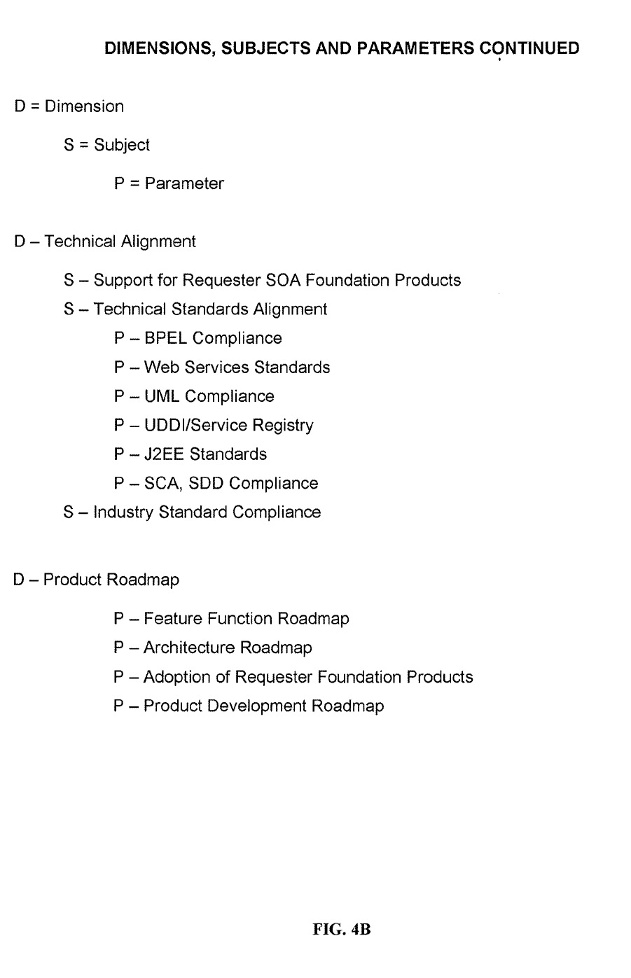

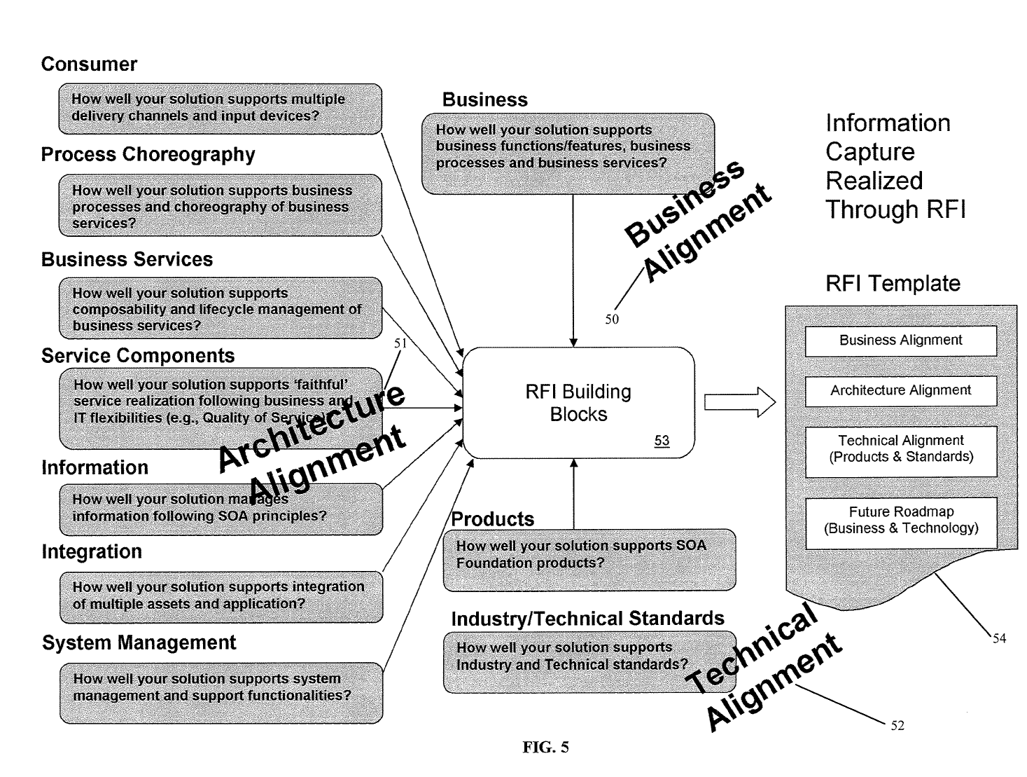

FIG. 4A and FIG. 4B in an aggregate show a listing of dimensions, subjects and parameters that may be used within the context of a request for information inquiry to ascertain capabilities of a particular independent software vendor for providing a particular independent software vendor solution for a particular request for information requester.

As is illustrated within FIG. 4A and FIG. 4B, the Business Alignment dimension and the Product Roadmap dimension each do not have any subjects aligned thereto, but rather only parameters that may eventually be afforded a ranking from “0” to “3”. In contrast, the Architectural Alignment dimension and the Technical Alignment dimension each have subjects aligned beneath the dimensions and parameters aligned beneath at least some of the subjects, although parameters are intended to be aligned beneath all of the subjects within the Architectural Alignment dimension and the Technical Alignment dimension.

As is understood by a person skilled in the art, the dimensions, subjects and parameters that are illustrated within the tabulations of FIG. 4A and FIG. 4B are intended as non-limiting and representative, rather than exhaustive. Thus, additional and more comprehensive listings of dimensions, subjects and parameters are not excluded, and are generally preferred, within the context of the instant embodiments, or any further embodiments, of the instant invention.

FIG. 5 shows a portion of an example questionnaire that may be derived, in-part, from the listing of dimensions, subjects and parameters that are enumerated in FIG. 4A and FIG. 4B to provide material for a relevant request for information that may be addressed to a plurality of candidate independent software vendors. As is illustrated in FIG. 5, the sole Business Alignment 50 inquiry correlates generally with the definition of Business Alignment 30 that is provided at FIG. 3.

In addition, the plurality of Architectural Alignment 51 inquiries correlates generally with the Architectural Alignment parameters that are illustrated in FIG. 4A. And as well, the Technical Alignment 52 inquiries correlate generally with the Technical Alignment parameters that are provided in FIG. 4B.

Within the context of the instant embodiments, independent software vendor Product Roadmap parameter inquiries in general, and more specifically additional Business Alignment, Architectural Alignment and Technical Alignment parameter inquiries, are intended to provide a consistent and direct correlation between the dimensions, subjects and parameters that are illustrated in FIG. 4A and FIG. 4B, and the basis of the request for information questionnaire that is illustrated in FIG. 5.

As is further illustrated in FIG. 5, the Business Alignment 50 inquiries, the Architecture Alignment 51 inquiries and the Technical Alignment 52 inquiries are characterized as request for information building blocks 53. In turn, the request for information building blocks 53 are used as subject matter for developing and populating a request for information template 54 that is a component of the part I information capture framework that is illustrated in FIG. 1.

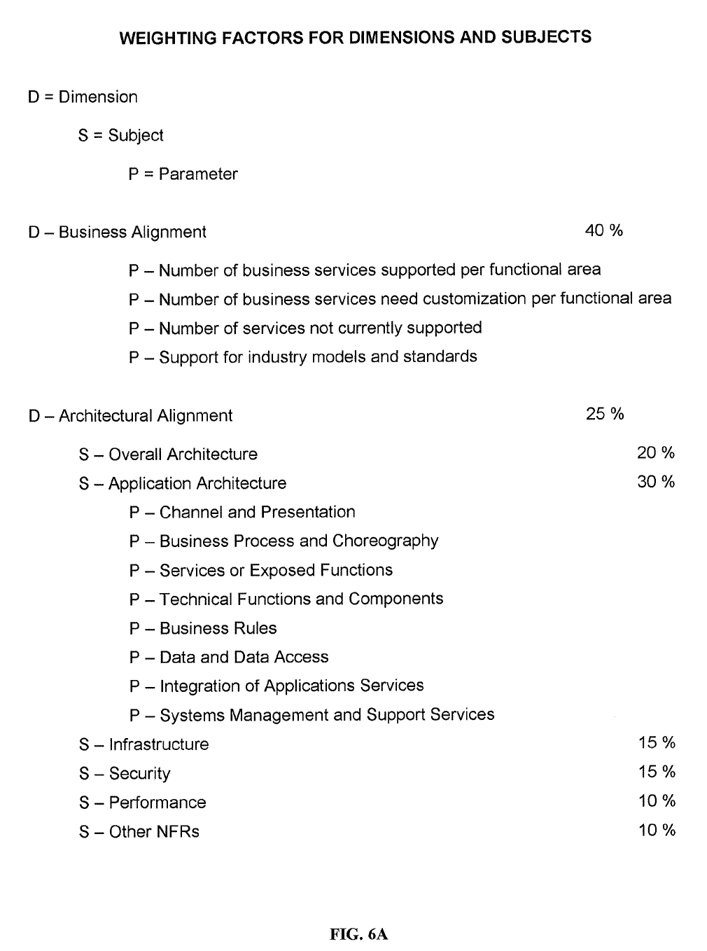

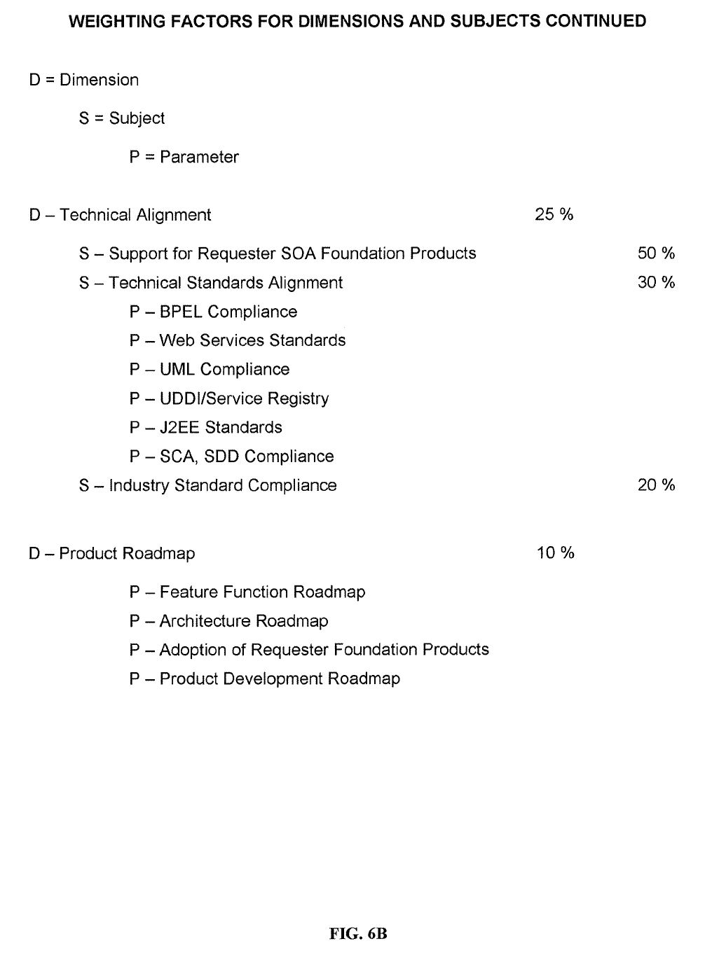

FIG. 6A and FIG. 6B show the same listing of dimensions, subjects and parameters that is illustrated in FIG. 4A and FIG. 4B, but wherein each of the four dimensions has been accorded a primary weighting factor and each of the subjects has also been accorded a secondary weighting factor. As is illustrated within FIG. 6A and FIG. 6B, the sum of the primary weighting factors for the total of four dimensions is equal to 100% and the sum of the secondary weighting factors for a plurality of subjects beneath a particular dimension is also equal to 100%. As is illustrated within FIG. 6A and FIG. 6B, the remaining parameters do not have any associated weighting factors, but in accordance with discussion above are rather afforded a ranking from “0” to “3.”

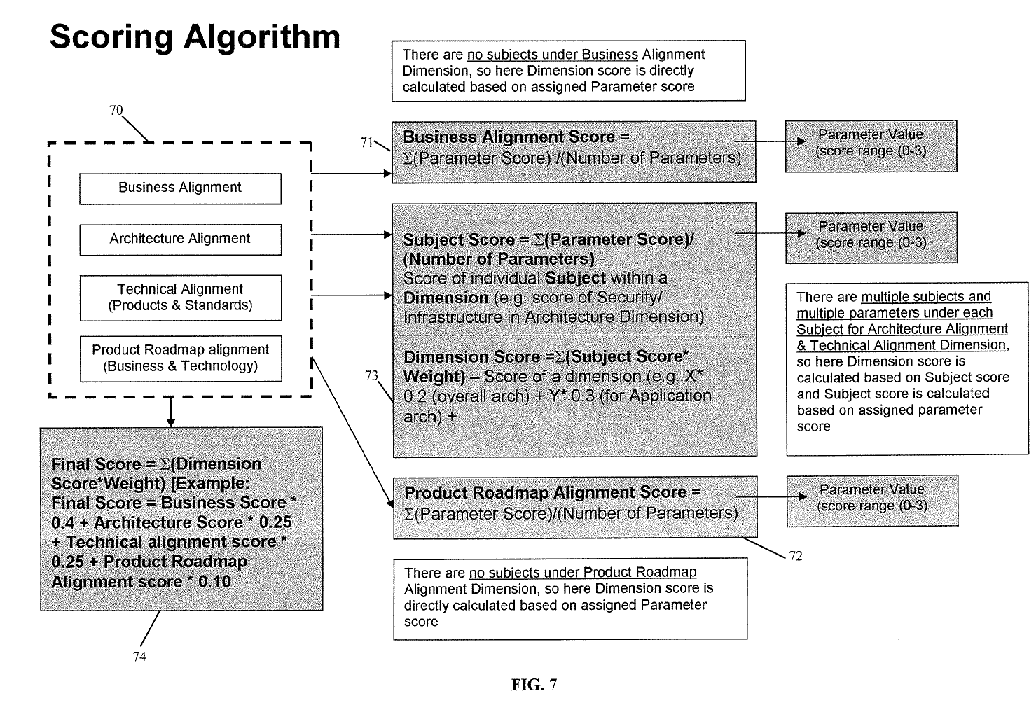

FIG. 7 shows in a first instance at reference numeral 70 the four dimensions of Business Alignment, Architectural Alignment, Technical Alignment and Product Roadmap Alignment that have previously been listed for consideration when evaluating and selecting an independent software vendor solution in accordance with the instant embodiments.

Within FIG. 7, and as is consistent with description provided above, both the Business Alignment dimension and the Product Roadmap Alignment dimension do not have any subjects designated there under. Thus, each of a Business Alignment dimension score 71 and a Product Roadmap Alignment dimension score 72 is determined as a summation of the individual parameter values that will range from “0” to “3” for those dimensions divided by the number of parameters.

In contrast, the Architectural Alignment dimension and the Technical Alignment dimension each have a plurality of subjects there under that in-turn have a plurality of parameters there under. Thus, within the context of the instant embodiments the Architectural Alignment dimension and the Technical Alignment dimension first provide in accordance with reference numeral 73 for determination of a subject score from a plurality of parameters, where the subject score is determined as a summation of relevant parameter scores divided by the number of parameters. The dimension score may then be determined as the summation of the relevant subject scores times their individual secondary weighting factors (i.e., the summation of the secondary weighted subject scores).

Finally, the embodiments provide for determining a final score in accordance with reference numeral 74 as a summation of individual dimension scores times their individual primary weighting factors (i.e., the summation of the primary weighted dimension scores).

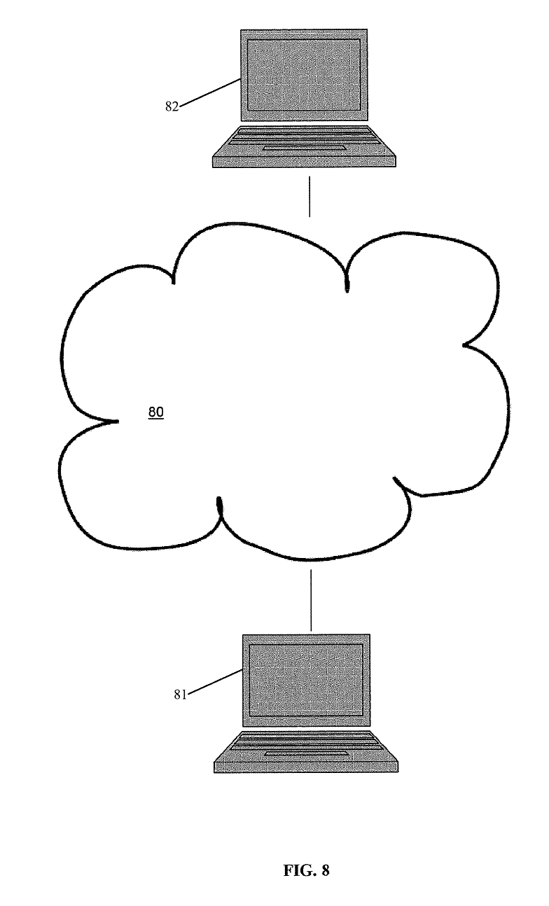

For reference purposes, FIG. 8 shows an apparatus that may be used for execution of the method of invention. FIG. 8 shows a request for information requester computer 81 and an independent software vendor computer 82, each of which is connected to a computer network 80. Thus, the illustration of apparatus in FIG. 8 contemplates that at least one, and plausibly all, process steps within the method of the invention may be executed within the context of the computer assisted apparatus that is illustrated in FIG. 8.

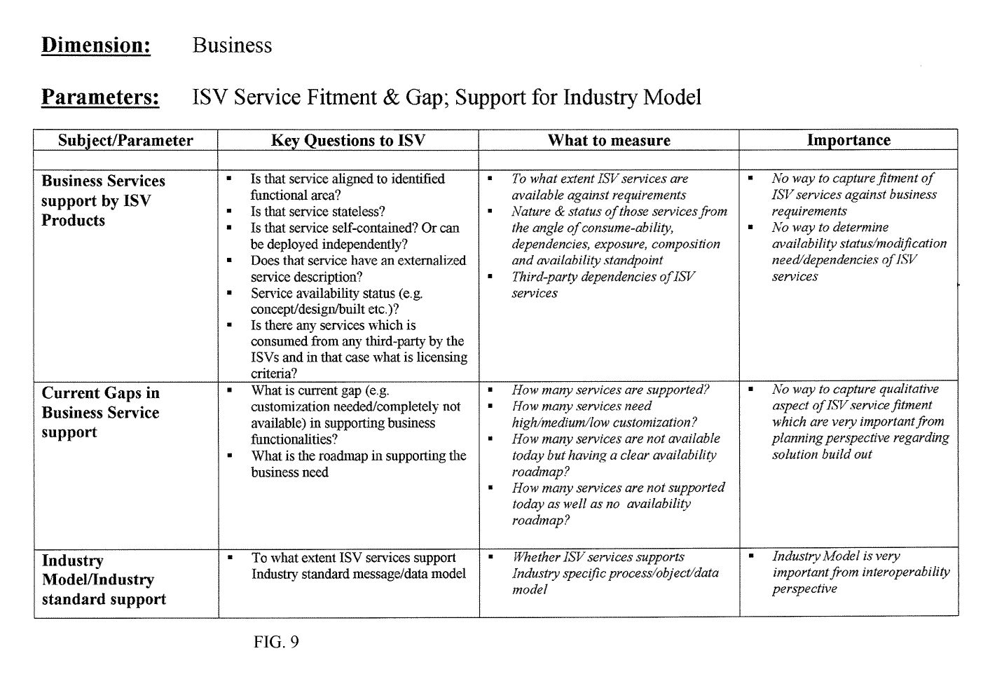

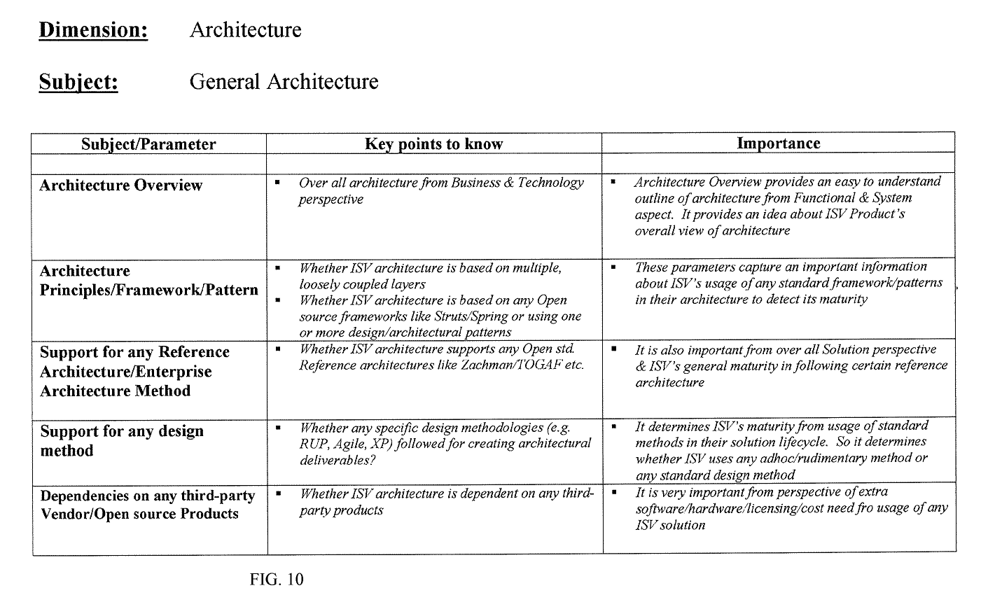

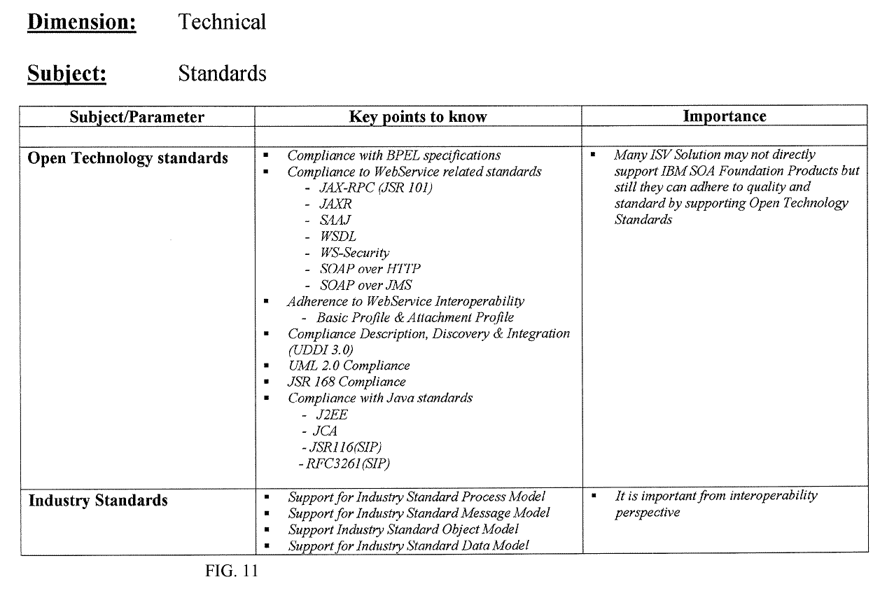

For further reference purposes, FIG. 9, FIG. 10 and FIG. 11 show additional non-limiting background information that is pertinent to development of request for information parameter inquiries for a Business Alignment dimension (i.e., FIG. 9 directed towards independent software vendor service fitment and gap parameters, and support for industry model parameter), Architectural Alignment dimension (i.e., FIG. 10 directed towards general architecture parameters) and Technical Alignment dimension (i.e., FIG. 11 directed towards standards parameters).

Each of FIG. 9, FIG. 10 and FIG. 11 correlates subjects and parameters with: (1) key questions to pose to an independent software vendor within a request for information; (2) what measurements are desirable; and (3) the importance of the particular parameter and subject combinations. In the alternative, the foregoing key questions and particular measurements may also be addressed as key points of knowledge, as in FIG. 10 and FIG. 11.

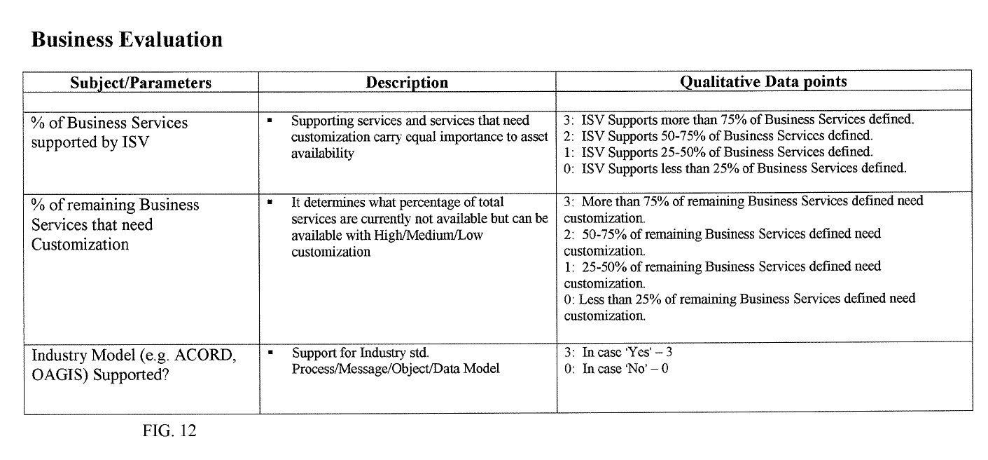

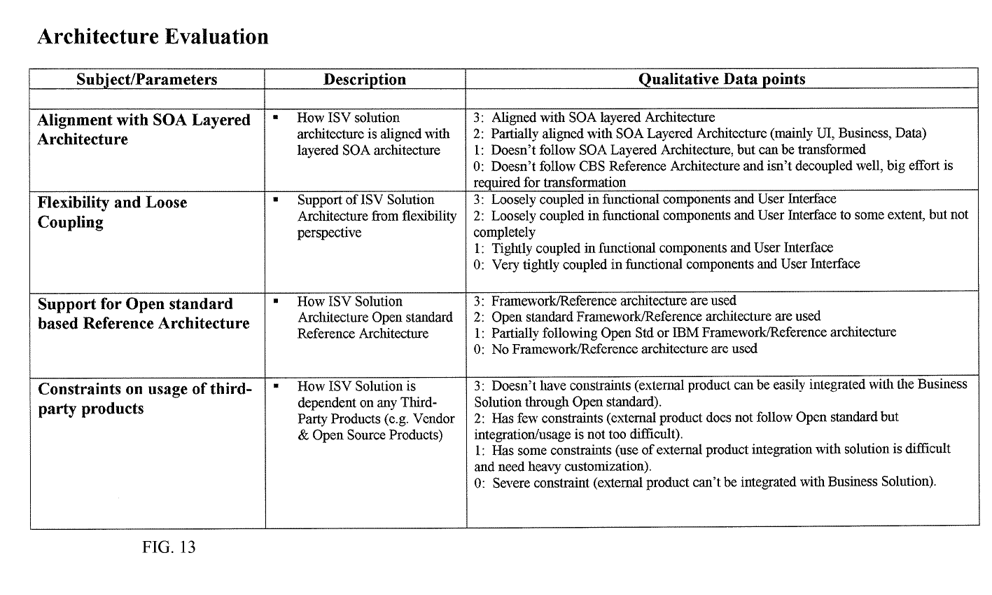

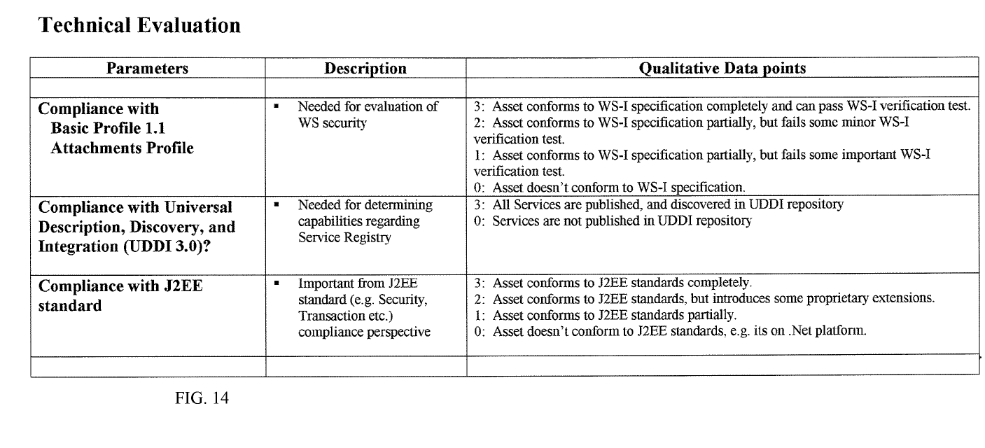

For further reference purposes, FIG. 12, FIG. 13 and FIG. 14 respectively show Business Alignment evaluation, Architecture Alignment evaluation and Technical Alignment evaluation scoring sheets that include subjects and parameters, descriptive materials related thereto, and qualitative data points for scoring.

The materials contained within FIG. 9 to FIG. 14 are intended as illustrative of request for information materials and scoring materials, and not limiting of request for information materials and scoring materials.

The foregoing description has been presented within the context of methodological process steps that are readily adapted to assistance by a computer apparatus. However, the embodiments of the invention are not necessarily so limited. Rather, the embodiments also consider that a computing apparatus suitably programmed may be included within the embodiments of the invention. As well, the embodiments also consider that a computer program product suitably available or memorialized may also be included within the embodiments.

Thus, as will be appreciated by one skilled in the art, aspects of the present invention may be embodied as a computer assisted method, a system or a computer program product.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing method, system and program product embodiments of the invention are illustrative of the invention rather than limiting of the invention. Revisions and modifications may be made to the method, system and program product embodiments of the invention while still providing additional embodiments of the invention, as are illustrated within the content of the following claims.

What is claimed is:

1. A method for evaluating an independent software vendor solution comprising:
defining within a computer system a structured information capture framework for evaluation of a plurality of independent software vendor solutions;
defining within the computer system a scoring model that correlates with the structured information capture framework and includes a multilevel weighted scoring algorithm;
inputting into the computer system parameter level data for the plurality of independent software vendor solutions while using the structured information capture framework; and
calculating for each of the plurality of independent software vendor solutions while using the multilevel weighted scoring algorithm a final score to provide an independent software vendor solution ranking.

2. The method of claim 1 further comprising selecting a particular independent software vendor solution from the plurality of independent software vendor solutions predicated upon the independent software vendor solution ranking.

3. The method of claim 1 wherein the multilevel weighted scoring algorithm uses:
inputted parameter level data to calculate a plurality of subject level scores;
a secondary weighting of the plurality of subject level scores to provide dimension level scores; and
a primary weighting of the plurality of dimension level scores to provide a final score.

4. The method of claim 3 wherein the subject level scores, the dimension level scores and the final score are calculated from the inputted parameter level data.

5. The method of claim 3 wherein the dimension level scores include dimensions selected from the group consisting of Business Alignment, Architectural Alignment, Technology Alignment and Product Roadmap Alignment dimensions.

6. The method of claim 5 wherein the Business Alignment dimension has a higher primary weighting than the Architectural Alignment and Technology Alignment dimensions that in turn have a higher primary weighting than the Product Roadmap Alignment dimension.

7. The method of claim 5 wherein:
the Business Alignment dimension has a primary weighting of 40%;
each of the Architectural Alignment and Technology dimensions has a primary weighting of 25%; and
the Product Roadmap Alignment dimension has a primary weighting of 10%.

8. A system for evaluating an independent software vendor solution comprising a computer programmed to:
define a structured information capture framework for evaluation of a plurality of independent software vendor solutions;
define a scoring model that correlates with the structured information capture framework and includes a multilevel weighted scoring algorithm;
receive parameter level data for the plurality of independent software vendor solutions while using the structured information capture framework; and
calculate for each of the plurality of independent software vendor solutions while using the multilevel weighted scoring algorithm a final score to provide an independent software vendor solution ranking.

9. The system of claim 8 wherein the computer is further programmed to select a particular independent software vendor solution from the plurality of independent software vendor solutions predicated upon the independent software vendor solution ranking.

10. The system of claim 8 wherein the multilevel weighted scoring model uses:
inputted parameter level data to calculate a plurality of subject level scores;
a secondary weighting of the plurality of subject level scores to provide a plurality of dimension level scores; and
a primary weighting of the plurality of dimension level scores to provide a final score.

11. The system of claim 10 wherein the subject level scores, the dimension level scores and the final score are calculated from the inputted parameter level data.

12. The system of claim 10 wherein the dimension level scores include dimensions selected from the group consisting of Business Alignment, Architectural Alignment, Technology Alignment and Product Roadmap Alignment dimensions.

13. The system of claim 12 wherein the Business Alignment dimension has a higher primary weighting than the Architectural Alignment and Technology Alignment dimensions that in turn have a higher primary weighting than the Product Roadmap Alignment dimension.

14. The system of claim 13 wherein:
the Business Alignment dimension has a primary weighting of 40%;
each of the Architectural Alignment and Technology dimensions has a primary weighting of 25%; and
the Product Roadmap Alignment dimension has a primary weighting of 10%.

15. A program product for evaluating an independent software vendor solution comprising a tangible medium encoded to:
define within a computer system a structured information capture framework for evaluation of a plurality of independent software vendor solutions;
define within the computer system a scoring model that correlates with the structured information capture framework and includes a multilevel weighted scoring algorithm;
receive within the computer system parameter level data for the plurality of independent software vendor solutions while using the structured information capture framework; and
calculate for each of the plurality of independent software vendor solutions while using the multilevel weighted scoring algorithm a final score to provide an independent software vendor solution ranking.

16. The tangible medium of claim 15 wherein the tangible medium is further encoded to select a particular independent software vendor solution from the plurality of independent software vendor solutions predicated upon the independent software vendor solution ranking.

17. The tangible method of claim 15 wherein the multilevel weighted scoring model uses:
inputted parameter level data to calculate a plurality of subject level scores;
a secondary weighting of the plurality of subject level scores to provide dimension level scores; and
a primary weighting of the plurality of dimension level scores to provide a final score.

18. The tangible medium of claim 17 wherein the subject level scores, the dimension level scores and the final score are calculated from the inputted parameter level data.

19. The tangible medium of claim 17 wherein the dimension level scores include dimensions selected from the group consisting of Business Alignment, Architectural Alignment, Technology Alignment and Product Roadmap Alignment dimensions.

20. The tangible medium of claim 19 wherein the Business Alignment dimension has a higher primary weighting than the Architectural Alignment and Technology Alignment dimensions that in turn have a higher primary weighting than the Product Roadmap Alignment dimension.
